(19) United States
(12) Patent Application Publication
(10) Pub. No.: US 2007/0190664 A1
(43) Pub. Date: Aug. 16, 2007

(54) METHOD OF DETECTING LIQUID RESIDUAL QUANTITY, FAILURE DETECTION DEVICE, LIQUID CONSUMING APPARATUS, AND LIQUID CONTAINER

(76) Inventor: Hitotoshi Kimura, Matsumoto-shi (JP)

Correspondence Address: STROOCK & STROOCK & LAVAN LLP, 180 MAIDEN LANE, NEW YORK, NY, 10038, US

(21) Appl. No.: 11/675,398

(22) Filed: Feb. 15, 2007

(30) Foreign Application Priority Data
Feb. 15, 2006 (JP) 2006-038578
Feb. 14, 2007 (JP) 2007-033981

(51) Int. Cl. G01N 1/00

(52) U.S. Cl. 436/174

(57) ABSTRACT

A method of detecting a liquid residual quantity in a liquid container, the liquid container including: a supply port through which a liquid is supplied to a liquid consuming apparatus; a liquid containing chamber that discharges the liquid stored therein through a liquid discharge port; a liquid detection chamber that is connected to the liquid containing chamber, a volume of which can be increased according to an inflow of the liquid from the liquid containing chamber and can be reduced when the inflow of the liquid from the liquid containing chamber stops; a detection unit for detecting a change of the volume of the liquid detection chamber; and a valve mechanism that is disposed between the liquid containing chamber and the liquid detection chamber and can block the inflow of the liquid from the liquid containing chamber to the liquid detection chamber, and wherein the detection unit performs a detection operation in a state where the volume of the liquid detection chamber is reduced by sucking the liquid in the liquid detection chamber through the supply port while the valve mechanism is closed and in a state where the valve mechanism is opened.

### BACKGROUND

1. Technical Field

The present invention relates to a method of detecting a failure in a detection unit that is provided in a liquid container for supplying a liquid, such as ink, to a liquid consuming apparatus, such as a liquid ejection head for ejecting a minute amount of liquid droplet, to a failure detection device, to a liquid consuming apparatus, and to a liquid container.

2. Related Art

A liquid ejection head of a textile printing apparatus, a micro dispenser, or a commercial recording apparatus that requires ultrahigh printing quality receives a liquid ejected from a liquid container that is detachably mounted on an apparatus main body. However, in order to prevent the liquid ejection head from being damaged due to idle printing, it is necessary to monitor a liquid residual quantity in the container.

There are suggested various methods that detect an ink residual quantity of an ink cartridge as a liquid container used in a recording apparatus.

As the liquid container that can detect the liquid residual quantity, there is known a liquid container having the following configuration. The liquid container includes a liquid containing chamber that discharges the liquid stored therein to a liquid detection chamber by pressurization of a pressure unit, and a detection unit that is disposed in a region to be blocked from a pressure of the pressure unit so as to detect a change of the volume of the liquid detection chamber (for example, see Patent Document 1).

In the liquid detection chamber, for example, a part of a sensor chamber is formed of a flexible film or the like. Even though a sufficient liquid residual quantity exists in the liquid containing chamber, when the liquid containing chamber is not pressurized by the pressure unit and then the liquid is not discharged from the liquid containing chamber, the volume of the liquid detection chamber is minimized. Then, if the liquid is discharged from the liquid containing chamber by the pressurization of the pressure unit, the volume of the liquid detection chamber increases according to the amount of the discharged liquid.

Meanwhile, when the pressurization of the pressure unit is performed, the amount of the liquid to be discharged from the liquid containing chamber gradually decreases according to a decrease in the liquid residual quantity of the liquid containing chamber. It the amount of the liquid to be discharged from the liquid containing chamber decreases, the volume of the liquid detection chamber decreases accordingly.

Then, the detection unit can detect whether or not a liquid containing amount of the liquid detection chamber reaches to a predetermined level at the time of the pressurization of the pressure unit.

Patent Document 1: JP-A-2004-351871

In the above-described liquid container, when the liquid is not discharged from the liquid containing chamber, the flexible film that constitutes a part of the sensor wall is urged by an appropriate urging unit in a direction in which the volume or the liquid detection chamber is reduced, such that the liquid detection chamber is kept to the minimum volume. Then, whenever ink is discharged from the liquid containing chamber and the volume of the liquid detection chamber increases, the flexible film repeats deformation to expand the volume of the liquid detection chamber. Accordingly, the flexible film needs to be formed of an expensive material having high durability, which causes an increase in Manufacturing cost of the liquid container.

Meanwhile, a liquid container having the following structure may be considered. In the liquid container, a liquid detection chamber is disposed in a region where a pressure is applied by a pressure unit, such that the volume of the liquid detection chamber does not repeatedly change. Further, a flexible film that constitutes a part of a sensor wall is urged by an appropriate urging unit in a direction in which the volume of the liquid detection chamber increases, such that the liquid detection chamber is kept to the maximum volume even though the liquid is not discharged from the liquid containing chamber.

However, in the liquid container having the above configuration, the volume of the liquid detection chamber is increased regardless of the pressurization state or unpressurization state by the pressure unit. Further, the volume of the liquid detection chamber is reduced from a time when the inflow of the liquid from the liquid containing chamber stops, that is, when the liquid is exhausted.

Accordingly, while the liquid consuming apparatus is used, it may be impossible to detect an erroneous operation of the detection unit that repeatedly detects presence of the liquid even though the liquid is exhausted.

### SUMMARY

An advantage of some aspects of the invention is to provide a method of detecting a liquid residual quantity, a failure detection device, a liquid consuming apparatus and a liquid container that can detect an erroneous operation of a detection unit, which repeatedly detects presence of a liquid even though the liquid is exhausted.

The advantage can be attained as at least one of the following aspects:

According to a first aspect of the invention, there is provided a method of detecting a liquid residual quantity in a liquid container. The liquid container includes a supply port through which a liquid is supplied to a liquid consuming apparatus, a liquid containing chamber that discharges the liquid stored therein through a liquid discharge port, a liquid detection chamber that is connected to the liquid containing chamber, a volume of which can be increased according to an inflow of the liquid from the liquid containing chamber and can be reduced when the inflow of the liquid from the liquid containing chamber stops, a detection unit for detecting a change of the volume of the liquid detection chamber, and a valve mechanism that is disposed between the liquid containing chamber and the liquid detection chamber and can block the inflow of the liquid from the liquid containing chapter to the liquid detection chamber. The detection unit performs a detection operation in a state where the volume of the liquid detection chamber is reduced by sucking the liquid in the liquid detection chamber through the supply port while the valve mechanist is closed and in a state where the valve mechanism is opened.

With this configuration, if the valve mechanism that is disposed between the liquid containing chamber and the liquid detection chamber is closed, and the liquid in the liquid detection chamber is sucked through the supply port, the liquid containing chamber becomes a pseudo liquid exhaustion state.

Accordingly, while the liquid consuming apparatus is used, if the liquid container becomes the pseudo liquid exhaustion state, the change of the volume of the liquid detection chamber is detected by the detection unit. Then, the malfunction of the detection unit can be checked.

That is, in a state where the liquid in the liquid detection chamber is sucked from the supply port while the valve mechanism is closed and in a state where the valve mechanism is opened, the volume of the liquid detection chamber is detected by the detection unit. Then, it is possible to detect presence/absence of the liquid of the liquid containing chamber and the malfunction of the detection unit.

In the method of detecting a liquid residual quantity according to the aspect of the invention, the liquid containing chamber may discharge the liquid stored therein through the liquid discharge port by pressurization of a pressure unit, and the liquid detection chamber may be disposed in a region where a pressure is applied by the pressure unit.

With this configuration, when a sufficient liquid residual quantity exists in the liquid containing chamber, the volume of the liquid detection chamber is increased regardless of pressurization or unpressurization by the pressure unit. Accordingly, the volume of the liquid detection chamber is reduced from a time when the inflow of the liquid from the liquid containing chamber stops, that is, when the liquid is exhausted.

Accordingly, even though pressurization or unpressurization to the liquid containing chamber by the pressure unit is repeated according to the supply of the liquid, the volume of the liquid detection chamber is not reduced, and the volume of the liquid detection chamber does not repeatedly change. Therefore, in a flexible film that constitutes a part of a sensor chamber, wear due to repetitive change is prevented.

In the method of detecting a liquid residual quantity according to the aspect of the invention, if the detection unit detects that the volume of the liquid detection chamber is increased when the liquid in the liquid detection chamber is sucked while the valve mechanism is closed, it may be judged that the detection unit malfunctions.

With this configuration, even though the liquid detection chamber becomes the pseudo liquid exhaustion state when the liquid in the liquid detection chamber is sucked while the valve mechanism is closed, if the detection unit detects that the volume of the liquid detection chamber is increased, the malfunction of the detection unit is checked.

According to a second aspect of the invention, there is provided a failure detection device for a liquid container. The liquid container includes a supply port through which a liquid is supplied to a liquid consuming apparatus, a liquid containing chamber that discharges the liquid stored therein through a liquid discharge port, a liquid detection chamber that is connected to the liquid containing chamber, a volume of which can be increased according to an inflow of the liquid from the liquid containing chamber and can be reduced when the inflow of the liquid from the liquid containing chamber stops, a detection unit for detecting a change of the volume of the liquid detection chamber, and a valve mechanism that is disposed between the liquid containing chamber and the liquid detection chamber and can block the inflow of the liquid from the liquid containing chamber to the liquid detection chamber. The failure detection device includes a closing mechanism that closes the valve mechanism, an suction mechanism that sucks the liquid in the liquid detection chamber through the supply port while the valve mechanism is closed, and a control unit that judges a malfunction of the detection unit if the detection unit detects that the volume of the liquid detection chamber is increased when the liquid in the liquid detection chamber is sucked through the supply port while the valve mechanism is closed.

With this configuration, in a state where the valve mechanism is closed and the inflow of the liquid from the liquid containing chamber stops, by sucking the liquid in the liquid detection chamber, the liquid detection chamber becomes a pseudo liquid exhaustion state.

Accordingly, while the liquid consuming apparatus is used, if the liquid container becomes the pseudo liquid exhaustion state, the change of the volume of the liquid detection chamber is detected by the detection unit. Then, the malfunction of the detection unit can be checked.

In the failure detection device for a liquid container according to another aspect of the invention, the liquid containing chamber may discharge the liquid stored therein through the liquid discharge port by pressurization of a pressure unit, and the liquid detection chamber may be disposed in a region where a pressure is applied by the pressure unit.

With this configuration, when a sufficient liquid residual quantity exists in the liquid containing chamber, the volume of the liquid detection chamber is increased regardless of pressurization or unpressurization by the pressure unit. Accordingly, the volume of the liquid detection chamber can be reduced from a time when the inflow of the liquid from the liquid containing chamber stops, that is, when the liquid is exhausted.

Accordingly, even though pressurization or unpressurization to the liquid containing chamber by the pressure unit is repeated according to the supply of the liquid, the volume of the liquid detection chamber is not reduced, and the volume of the liquid detection chamber does not repeatedly change. Therefore, in a flexible film that constitutes a part of a sensor chamber, wear due to a repetitive change is prevented.

According to a third aspect of the invention, a liquid consuming apparatus includes the above-described failure detection device. The liquid container is detachably mounted, and the liquid supplied from the supply port of the liquid container is ejected from a ejection head as a minute amount of liquid droplet.

With this configuration, a liquid residual quantity of the liquid container can be detected by the detection unit, and the malfunction of the detection unit can be checked. Therefore, the ejection head can be reliably prevented from being damaged due to idle printing.

According to a fourth aspect of the invention, there is provided a method of detecting a liquid residual quantity in a liquid container including; a supply port for supplying a liquid to a liquid consuming apparatus therethrough; a liquid containing chamber that stores the liquid therein; a liquid detection chamber that is connected to the liquid containing chamber, a volume of which can be increased according to an inflow of the liquid from the liquid containing chamber and can be reduced when the inflow of the liquid from the liquid containing chamber stops; a detection unit for detecting a change of the volume of the liquid detection chamber; and a valve mechanism that is disposed between the liquid containing chamber and the liquid detection chamber and can block the inflow of the liquid from the liquid containing chamber to the liquid detection chamber, wherein the method comprising closing the valve mechanism; sucking the liquid through the supply port to reduce the volume of the liquid detection chamber; and detecting the change of the volume of the liquid detection chamber.

With this configuration, it is possible to detect presence/absence of the liquid of the liquid containing chamber and the malfunction of the detection unit. In the method of detecting a liquid residual quantity in the liquid container, the detection unit is preferably judged as abnormal when a signal output from the detection unit shows that the volume of the liquid detection chamber is increased. Or, the detection unit is preferably judged as normal when a signal output from the detection unit shows that the volume of the liquid detection chamber is reduced.

With this configuration, it is possible to detect presence/absence of the liquid of the liquid containing chamber and the malfunction of the detection unit.

According to a fifth aspect of the invention, there is provided a liquid container comprising: a first pressure chamber in which a first pressurized fluid can be introduced; a second pressure chamber in which a second pressurized fluid can be introduced, and which is not in fluid communication with the first pressure chamber; a liquid containing chamber that stores a liquid therein; a liquid detection device for detecting a change of the volume of the liquid containing chambers including a liquid detection chamber that is connected to the liquid containing chamber, and a volume of which can change according to an inflow amount of the liquid from the liquid containing chamber; and a flexible member that defines at least a part of a flow passage connecting the liquid containing chamber and the liquid detection chamber to each other and can block the flow passage, wherein the liquid detection chamber and the liquid containing chamber are disposed so as to reduce its volume due to the first pressurized fluid to be introduced in the first pressure chamber, and wherein the flexible member is disposed so as to block the flow passage due to the second pressurized fluid to be introduced in the second pressure chamber. With this configuration, it is possible to detect presence/absence of the liquid of the liquid containing chamber and the malfunction of the detection unit. In the liquid container, the liquid detection chamber is preferably formed by sealing an opening formed at its upper surface with a film that is deformable according to a liquid containing amount of the liquid detection chamber, and the detection unit is preferably disposed at the bottom of the liquid detection chamber.

With this configuration, it is possible to detect presence/absence of the liquid of the liquid containing chamber and the malfunction of the detection unit.

In the liquid container, a moving member is preferably attached to the film so as to move by the deformation of the film corresponding to a change of the liquid containing amount of the liquid detection chamber.

With this configuration, it is possible to detect presence/absence of the liquid of the liquid containing chamber and the malfunction of the detection unit.

In the liquid container, the detection unit is preferably a piezoelectric detection unit that has a recess portion formed in the liquid detection chamber so as to form a closed space in cooperation with one surface parallel to a horizontal surface of the moving member in a state where the moving member moves to the predetermined position according to the liquid containing amount of the liquid detection chamber, and

the piezoelectric detection unit preferably applies vibration to the recess portion and detects a free vibration state according to the applied vibration.

With this configuration, it is possible to detect presence/absence of the liquid of the liquid containing chamber and the malfunction of the detection unit. In the liquid container, the moving member preferably has, in a region facing a vibration surface of the piezoelectric detection unit, a surface substantially parallel to the vibration surface.

With this configuration, it is possible to detect presence/absence of the liquid of the liquid containing chamber and the malfunction of the detection unit. In the liquid container, the moving member is preferably urged by an urging unit in a direction opposite to a direction in which the piezoelectric detection unit is disposed.

With this configuration, it is possible to detect presence/absence of the liquid of the liquid containing chamber and the malfunction of the detection unit. In the liquid container, the urging unit is preferably formed of an elastic member.

With this configuration, it is possible to detect presence/absence of the liquid of the liquid containing chamber and the malfunction of the detection unit.

According to the method of detecting a liquid residual quantity of the first aspect of the invention, while the liquid consuming apparatus is used, if the liquid container becomes the pseudo liquid exhaustion state, the change of the volume of the liquid detection chamber is detected by the detection unit. Then, the malfunction of the detection unit can be checked.

Accordingly, in a state where the valve mechanism is closed and the liquid in the liquid detection chamber is sucked through the supply port and in a state where the valve mechanism is opened, the volume of the liquid detection chamber is detected by the detection unit. Then, it is possible to detect presence/absence of the liquid of the liquid containing chamber and the malfunction of the detection unit.

According to the failure detection device of the second aspect of the invention, while the liquid consuming apparatus is used, if the liquid container becomes the pseudo liquid exhaustion state, the change of the volume of the liquid detection chamber is detected by the detection unit. Then, the malfunction of the detection unit can be checked.

According to the liquid consuming apparatus of the third aspect of the invention, the ejection head can be reliably prevented from being damaged due to idle printing.

According to the method of detecting a liquid residual quantity of the fourth aspect of the invention, while the liquid consuming apparatus is used, if the liquid container becomes the pseudo liquid exhaustion state, the change of the volume of the liquid detection chamber is detected by the detection unit. Then, the malfunction of the detection unit can be checked.

According to the liquid container of the fifth aspect of the invention, it is possible to detect presence/absence of the liquid of the liquid containing chamber and the malfunction of the detection unit.

The present disclosure relates to the subject matter contained in Japanese patent application No. 2006-038578 filed on Feb. 15, 2006, which is expressly incorporated herein by reference in its entirety.

### BRIEF DESCRIPTION OF THE DRAWINGS

The invention will be described with reference to the accompanying drawings, wherein like numbers reference like elements.

FIG. 1 is a block diagram of a failure detection device according to an embodiment of the invention.

FIG. 2 is a longitudinal cross-sectional view of a liquid container as a subject for failure detection.

FIG. 3 is a longitudinal cross-sectional view of a liquid container when a liquid of a liquid containing chamber becomes an exhaustion state.

FIG. 4 is a longitudinal cross-sectional view of a liquid container when an on/off valve mechanism is closed and the liquid container becomes a pseudo liquid exhaustion state.

FIG. 5 is a flowchart showing a procedure of a method of detecting a failure in the failure detection device shown in FIG. 1.

### DESCRIPTION OF EXEMPLARY EMBODIMENTS

Hereinafter, a preferred embodiment of a method of detecting a liquid residual quantity, a failure detection device, and a liquid consuming apparatus according to the invention will be described in detail with reference to the accompanying drawings.

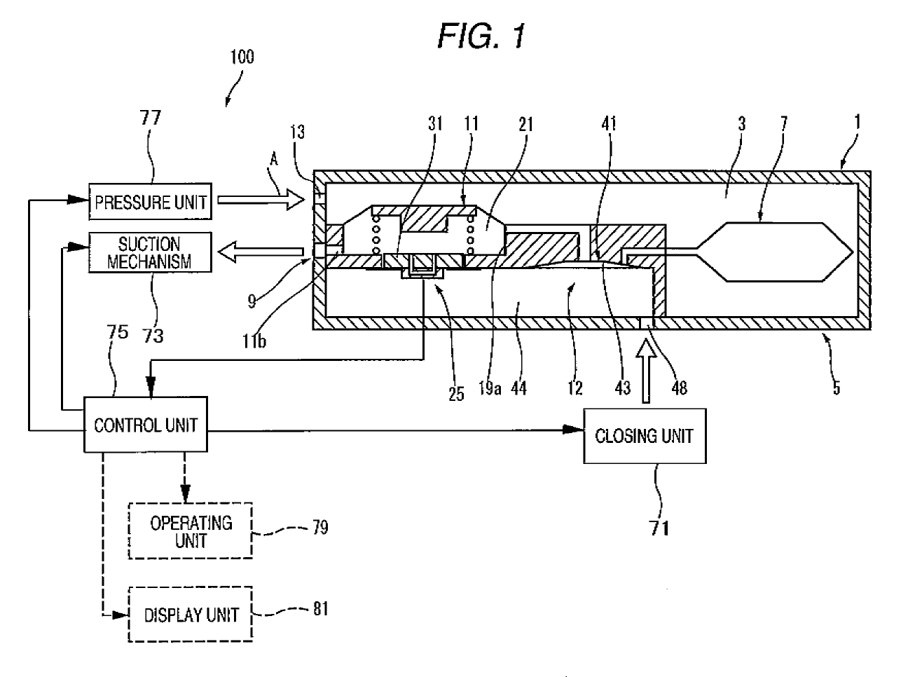

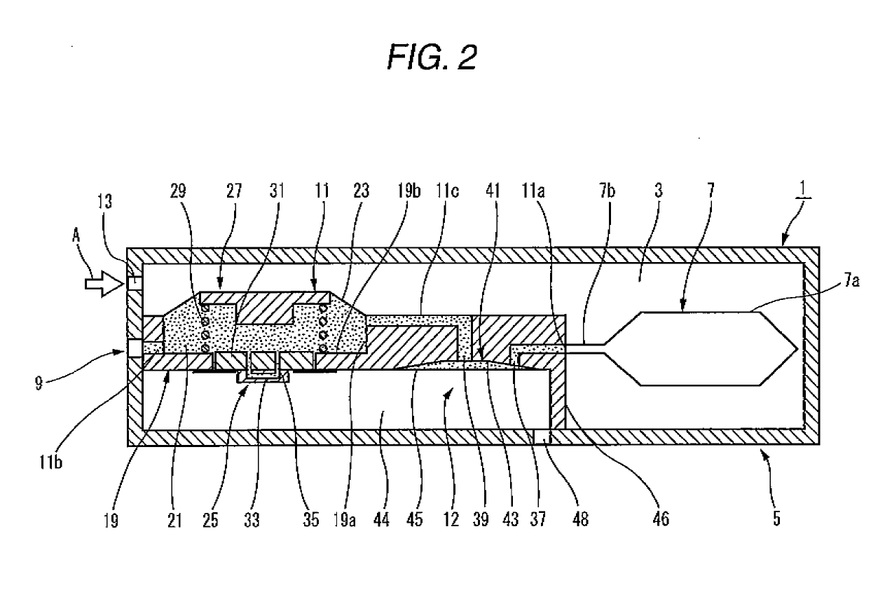

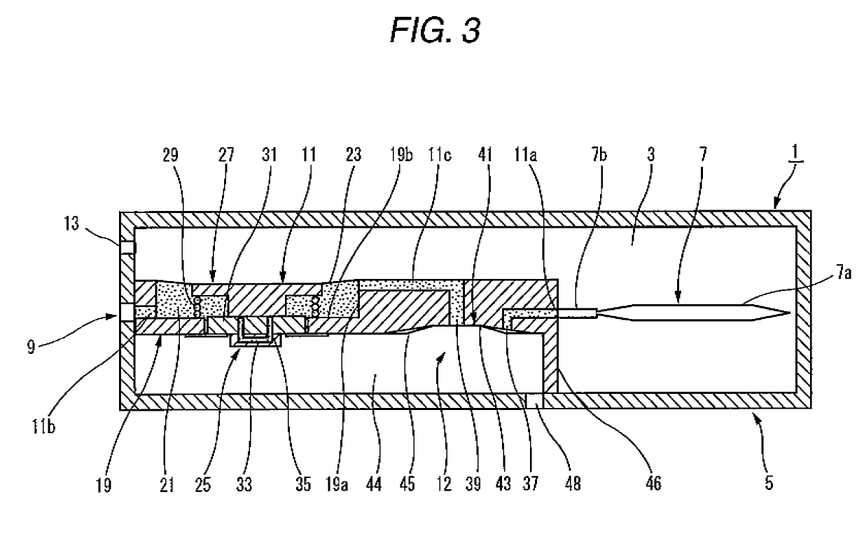

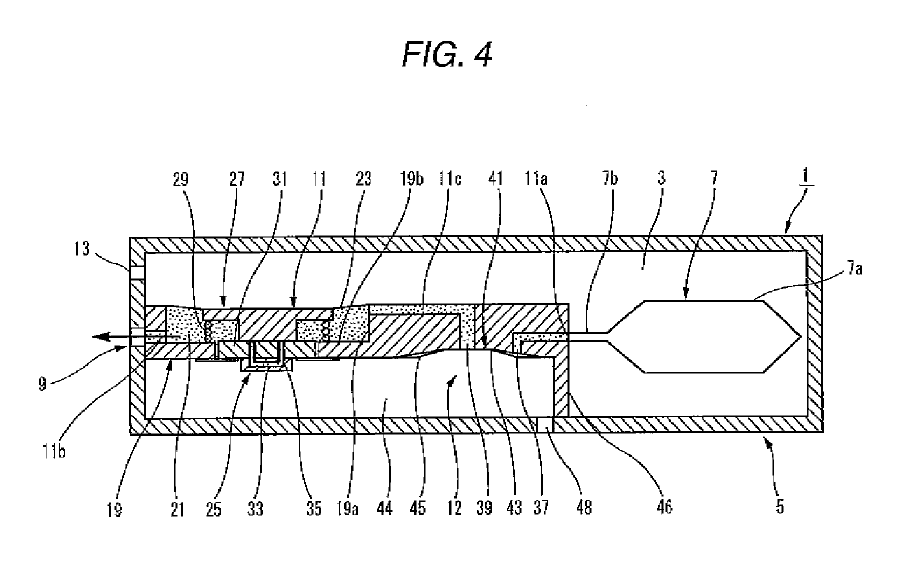

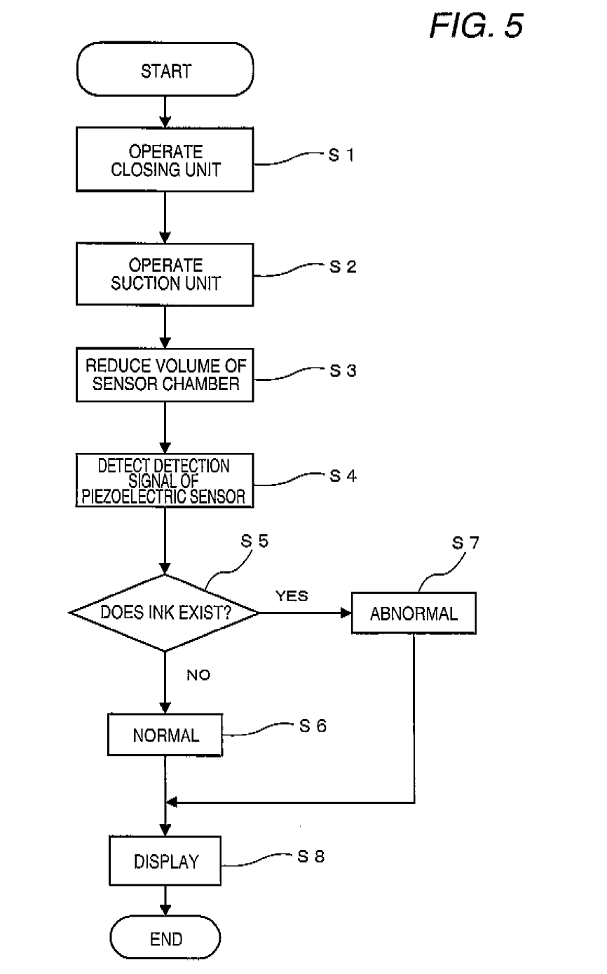

FIG. 1 is a block diagram of a failure detection device according to an embodiment of the invention. FIG. 2 is a longitudinal cross-sectional view of a liquid container as a subject for failure detection. FIG. 3 is a longitudinal cross-sectional view of a liquid container when a liquid of a liquid containing chamber becomes an exhaustion state. FIG. 4 is a longitudinal cross-sectional view of a liquid container when an on/off valve mechanism is closed and the liquid container becomes a pseudo liquid exhaustion state. FIG. 5 is a flowchart showing a procedure of a method of detecting a failure in the failure detection device shown in FIG. 1.

In this embodiment, a description will be given by way of a method of detecting a liquid residual quantity, a failure detection device and a liquid consuming apparatus corresponding to a liquid container having a liquid containing chamber and a liquid detection chamber that are pressurized simultaneously.

As shown in FIG. 1, a failure detection device 100 of this embodiment detects a failure of an ink detection unit (detection unit) 11 provided in a liquid container 1. The liquid container 1 is an ink cartridge that is detachably mounted on a cartridge mounting portion of an inkjet recording apparatus (liquid consuming apparatus) and supplies ink (liquid) to a printing head (ejection head) provided in the recording apparatus.

The failure detection device 100 includes, as basic components, a closing unit 71 that serves as a closing mechanism for closing the on/off valve mechanism 12, an suction mechanism 73 that performs choke suction for sucking ink of a sensor chamber (liquid detection chamber) 21 through a supply port 9 of the liquid container 1 in a state where the on/off valve mechanism 12 is closed, and a control unit 75 that, at the time of the choke suction, when the ink detection detects that the volume of the sensor chamber 21 is increased, judges the malfunction of the ink detection unit 11. In addition, the control unit 75 may be configured to judge the ink detection unit 11 as normal if the ink detection detects that the volume of the sensor chamber 21 is decreased at the time of the choke suction.

The failure detection device 100 further includes a pressure unit 77 that supplies pressurized air to a pressure chamber 3 (first pressure chamber) of the liquid container 1, an operating unit 79 through which a failure detection procedure is input, and a display unit 81 that displays a failure detection result.

The liquid container 1 as a subject for failure detection will now be described.

As shown in FIG. 2, the liquid container 1 includes a container main body 5 that partitions a pressure chamber 3 to be pressurized by the pressure unit 77 or a pressure unit of an ink jet recording apparatus, an ink pack (liquid containing chamber) 7 that stores ink, is accommodated in the pressure chamber 3, and discharges ink stored therein from a discharge port (liquid discharge port) 7b when the pressure chamber 3 is pressurized, an ink supply port (supply port) 9 from which ink is supplied to a printing head of the ink jet recording apparatus as an external liquid consuming apparatus, an ink detection unit (detection unit) 11 that is interposed between the ink pack 7 and the ink supply port 9 so as to detect an ink residual quantity, and an on/off valve mechanism 12 that is disposed between the ink pack 7 and the ink detection unit 11 so as to block an inflow of ink from the ink pack 7 to the ink detection unit 11.

The container main body 5 has the airtight pressure chamber 3, a pressure port 13 serving as a pressurized gas injection portion, through which the pressure unit (not shown) supplies pressurized air to the pressure chamber 3 as indicated by an arrow A, and a space 44 (second pressure chamber) that is exposed to the atmosphere.

The pressure chamber 3 is a region where the pressure of the pressurized gas to be supplied by the pressure unit 77 of the failure detection device 100 or the pressure unit of the ink jet recording apparatus is applied. Accordingly, the pressure applied from the pressure unit acts on both the ink pack 7 accommodated in the pressure chamber 3 and the ink detection unit 11.

The ink pack 7 has a flexible pouch body 7a formed by adhering edges of aluminum-laminated multilayer films, on which an aluminum layer is laminated on a flexible resin film layer, to each other. A cylindrical discharge port 7b, to which an ink inlet port (liquid inlet port) 11a of the ink detection unit 11 is connected, is bonded to one end of the pouch body 7a. Since the ink pack 7 uses the aluminum-laminated multilayer films, a high gas barrier property is secured.

The ink pack 7 and the ink detection unit 11 are connected to each other by engaging the ink inlet port 11a with the discharge port 7b. That is, the ink pack 7 and the ink detection unit 11 can be detached from each other by releasing the engagement of the discharge port 7b and the ink inlet port 11a.

Moreover, in the discharge port 7b, a packing that connects the discharge port 7b and the ink inlet port 11a airtight is provided. Then, ink is filled into the ink pack 7 in advance at a high degree of deaeration before the ink detection unit 11 is connected to the ink pack 7.

The ink detection unit 11 includes a detection unit case 19 that has a concave space 19a communicating the ink inlet port 11a connected to the discharge port 7b of the ink pack 7 and an ink outlet port (liquid outlet port) 11b connected to the ink supply port 9, a flexible film 23 that seals an opening of the concave space 19a so as to partition a sensor chamber (liquid detection chamber) 21, a pressure detection unit 25 that is provided at a bottom 19b of the concave space 19a, a pressure receiving plate (moving member) 27 that is fixed to the flexible film 23 to face the pressure detection unit 25, and a compressed coil spring (urging unit) 29 that is provided between the pressure receiving plate 27 and the bottom 19b in a compressed state and elastically urges the pressure receiving plate 27 and the flexible film 23 in a direction id which the volume of the sensor chamber 21 is increased.

The sensor chamber 21 is preferably configured by sealing the opening of the concave space 19a provided in the detection unit case 19 as a member forming the sensor chamber 21 with the flexible film 23. The flexible film 23 functions as a diaphragm that applies displacement to the pressure receiving plate 27 according to the pressure of ink to be supplied to the sensor chamber 21. In order to enable detection of a slight change of pressure of ink and to improve detection accuracy, what is necessary is that the flexible film 23 has enough flexibility. With this configuration, the sensor chamber 21 can be formed by a simple manufacturing process of sealing the opening of the concave space 19a with the flexible film 23 using thermal welding. Accordingly, the airtight sensor chamber 21 can be easily manufactured.

In the detection unit case 19, an ink discharge path 11c is integrally formed at one end of a peripheral wall partitioning the concave space 19a, and the ink outlet port 11b that communicates with the ink supply port 9 is formed to pass through a peripheral wall facing the ink discharge path 11c. Though not shown, a valve mechanism is provided in the ink supply port 9. The valve mechanism opens a flow passage when the ink cartridge is mounted on the cartridge mounting portion of the ink jet recording apparatus and an ink supply needle provided in the cartridge mounting portion is inserted into the ink supply port 9.

The pressure detection unit 25 of the ink detection unit 11 includes a bottom plate 31 that is separated from the pressure receiving plate 27 by an urging force of the compressed coil spring 29 when ink can be supplied from the ink pack 7 to the sensor chamber 21, an ink guide path 33 that is a recess portion formed in the bottom plate 31, and a piezoelectric sensor (piezoelectric detection unit) 35 that applies vibration to the ink guide path 33 and detects a free vibration state according to the applied vibration.

The piezoelectric sensor 35 can detect different free vibration states (amplitude of residual vibration or change of frequency) according to whether or not the ink guide path 33 is covered with the pressure receiving plate 27.

Accordingly, for example, a control unit provided in the inkjet recording apparatus can detect deformation of the flexible film 23 supporting the pressure receiving plate 27 according to the free vibration state detected by the piezoelectric sensor 35, thereby detecting a change of the volume of the sensor charter 21. That is, when the ink detection unit 11 that is a detection unit is connected to a liquid detection device provided at a side of the ink jet recording apparatus, the detection unit 11 serves as a part of the liquid detection device.

An urging direction of the compressed coil spring 29 urging the pressure receiving plate 27 is a direction in which the volume of the sensor chamber 21 is increased (opposite direction to a direction in which the piezoelectric sensor 35 is disposed), as described above. Accordingly, in a normal state (in a state where ink of the ink pack 7 is not exhausted), as shown in FIG. 2, the pressure receiving plate 27 and the bottom plate 31 are separated from each other.

When a sufficient ink residual quantity exists in the ink pack 7, the separation state is kept even though the pressure by the pressure unit is applied to the pressure chamber 3. That is, the compressed coil spring 29 has an urging force that separates the pressure receiving plate 27 from the bottom 19b against the pressure by the pressure unit in cooperation with an inflow pressure of ink flowing from the ink pack 7 to the sensor chamber 21 by the pressurization of the pressure unit.

Meanwhile, as shown in FIG. 3, when ink of the ink pack 7 is exhausted, and the inflow of ink from the ink pack 7 stops or ink is absorbed from the ink supply port 9, the pressure receiving plate 27 moves against the urging force of the compressed coil spring 29 and comes into close contact with the bottom plate 31 by a negative pressure in the sensor chamber 21.

The ink guide path 33, which is the recess portion formed in the bottom plate 31, partitions a detection space in cooperation with the pressure receiving plate 27 in a state where the pressure receiving plate 27 comes into close contact with the bottom plate 31, as shown in FIG. 3. Further, as shown in FIG. 2, in a state where the pressure receiving plate 27 is separated from the bottom plate 31, the ink guide path 33 is opened and communicates with the sensor chamber 21. The pressure receiving plate 27 has, in a region facing a vibration surface of the piezoelectric sensor 35, a surface substantially parallel to the vibration surface.

In the ink detection unit 11, if ink is supplied from the ink pack 7 to the sensor chamber 21 by pressurization of the ink pack 7 due to pressurized air to be supplied to the pressure chamber 3, the inflow pressure of ink deforms the flexible film 23 to be swelled upward in cooperation with the urging force of the compressed coil spring 29. If the pressure receiving plate 27 is separated from the bottom plate 31, the ink guide path 33 is opened and communicates with the sensor chamber 21, and thus ink is supplied from the ink supply port 9 to the printing head through the sensor chamber 21.

Even if the pressure chamber 3 is in a predetermined pressurization state, when ink contained in the ink pack 7 decreases, the amount of ink to be supplied from the ink pack 7 to the sensor chamber 21 decreases. Then, since the pressure of the sensor chamber 21 decreases, the pressure receiving plate 27 approaches the bottom plate 31 having the ink guide path 33.

That is, if the liquid containing amount in the sensor chamber 21 is a predetermined amount or less, the pressure receiving plate 27 partitions the detection space in cooperation with the ink guide path 33 as a vibration reaction region. Accordingly, a change of free vibration state to be detected by the piezoelectric sensor 35 markedly appears, and thus a time or state where the liquid containing amount in the sensor chamber 21 reaches a predetermined level can be accurately and reliably detected. In this embodiment, a time at which the pressure receiving plate 27 comes into close contact with the bottom plate 31 by the decrease in pressure of the sensor chamber 21 and partitions the detection space in cooperation with the ink guide path 33 is set to a state where ink of the ink pack 7 is exhausted.

The on/off valve mechanism 12 is disposed between the ink pack 7 and the ink detection unit 11 and blocks the inflow of ink from the ink pack 7 to the ink detection unit 11. The on/off valve mechanism 12 has a valve chamber 41 that causes an inlet port 37 communicating with the ink pack 7 to communicate with an outlet port 39 communicating with the sensor chamber 21. The inlet port 37 communicates with the ink pack 7 through the liquid inlet port 11a. The outlet port 39 communicates with the sensor chamber 21 through the ink discharge path 11c.

The valve chamber 41 is configured by sealing an opening of a concave place 43 provided in the detection unit case 19 as a member forming the valve chamber 41 with a diaphragm 45. With this configuration, the valve chamber 41 can be formed by a simple manufacturing process of sealing the opening of the concave place 43 with the diaphragm 45 through thermal welding. Accordingly, the airtight valve chamber 41 can he easily manufactured.

The diaphragm 45 is formed of a deformable film (flexible member). The outlet port 39 formed in the valve chamber 41 can be closed by the deformation (close adhesion) of the diaphragm 45. A space 44, in which the diaphragm 45 is disposed, is defined by the pressure chamber 3 and a partition wall 46. The space 44 communicates with the atmosphere through an opening 48.

In this embodiment, the outlet port 39 formed in the valve chamber 41 is closed by the deformation of the diaphragm 45 due to a negative pressure of the valve chamber 41 generated through the suction of ink from the ink supply port 9. That is, the outlet port 39 can be closed by setting the valve chamber 41 communicating with the sensor chamber 21 through the outlet port 39 to have a negative pressure due to ink of the sensor chamber 21 to be absorbed from the ink supply port 9 and causing the diaphragm 45 to be deformed by the negative pressure.

Specifically, it is not necessary to separately provide a mechanism for applying an external force in the diaphragm 45, and thus the on/off valve mechanism 12 can be simply configured.

Accordingly, as shown in FIG. 4, when the outlet port 39 is closed by setting the valve chamber 41 to the negative pressure through the suction of ink from the ink supply port 9, the inflow of ink from the ink pack 7 is blocked. In this state, if ink is further absorbed from the ink supply port 9, the pressure in the sensor chamber 21 decreases, and thus the pressure receiving plate 27 approaches the bottom plate 31 and finally comes into close contact with the bottom plate 31.

That is, if the on/off valve mechanism 12 blocks the conduction to the ink pack 7, the ink pack 7 can become a pseudo ink exhaustion state. Thereafter, if the pressure chamber 3 is pressurized, the on/off valve mechanism 12 is opened by the pressure from the ink pack 7, and the sensor chamber 21 returns to a state where ink is present.

In the liquid container 1, when the ink containing amount (liquid containing amount) of the sensor chamber 21 is a predetermined amount or less, the pressure receiving plate 27 partitions the detection space serving as the vibration reaction region in cooperation with the ink guide path 33. Accordingly, a frequency of acoustic impedance corresponding to the ink guide path 33 appears. This frequency becomes lower than a frequency by acoustic impedance when the pressure receiving plate 27 is separated from the bottom plate 31, and a difference is noticeable. For this reason, the change of free vibration state to be detected by the piezoelectric sensor 35 markedly appears. Therefore, the time or state where the ink containing amount in the sensor chamber 21 reaches the predetermined level can be accurately and reliably detected.

That is, according to the method of detecting a liquid residual quantity of this embodiment, for the above-described liquid container 1, the ink detection unit 11 can perform a detection operation in a state where choke suction for absorbing ink in the liquid detection chamber 21 through the supply port 9 is performed while the on/off valve mechanism 12 is closed and the volume of the sensor chamber 21 is reduced, and in a state where the on/off valve mechanism 12 is opened.

Then, when the choke suction is performed in a state where the on/off valve mechanism 12 is closed and the inflow of ink from the ink pack 7 is blocked, the sensor chamber 21 becomes the pseudo ink exhaustion state.

Accordingly, in the liquid container 1 in which the ink pack 7 and the sensor chamber 21 are pressurized simultaneously, while the ink jet recording apparatus is used, if the liquid container 1 becomes the pseudo ink exhaustion state, the change of the volume of the sensor chamber 21 can be detected by the ink detection unit 11. Therefore, the malfunction of the ink detection unit 11 can be checked.

That is, in a state where the on/off valve mechanism 12 is closed and the choke suction of sucking liquid in the sensor chamber 21 through the supply port is performed and in a state where the on/off valve mechanism 12 is opened, the ink detection unit 11 can detect the volume of the sensor chamber 21. Therefore, it is possible to detect presence/absence of ink in the sensor chamber 21 and the malfunction of the ink detection unit 11.

For example, when an ink presence signal is detected in a state where the on/off valve mechanism 12 is opened and an ink absence signal is detected in a state where the on/off valve mechanism 12 is closed, ink exists in the ink pack 7.

Further, when the ink absence signal is detected in a state where the on/off valve mechanism 12 is opened and the ink absence signal is also detected in a state where the on/off valve mechanism 12 is closed, ink does not exist in the ink pack 7.

In addition, when the ink absence signal or the ink presence signal is detected in a state where the on/off valve mechanism 12 is opened and the ink presence signal is detected in a state where the on/off valve mechanism 12 is closed, the piezoelectric sensor 35 malfunctions.

When the liquid container 1 is mounted on the failure detection device 100, as shown in FIG. 1, the space 44 communicates with the closing unit 71 through the opening 48.

Examples of the closing unit 71 serving as a closing mechanism that closes the on/off valve mechanism 12 include an actuator that supplies pressurized air. Accordingly, if pressurized air is supplied to the space 44 by the closing unit 71, the diaphragm 45 is displaced to come into close contact with the concave place 43 and to close the outlet port 39. Therefore, the inflow of the liquid from the ink pack 7 to the sensor chamber 21 can be blocked.

Moreover, the on/off valve mechanism 12 may close the outlet port 39 formed in the valve chamber 41 by the deformation of the diaphragm 45 due to the negative pressure of the valve chamber 41 generated through the suction of ink from the ink supply port 9 by the suction mechanism 73. In this case, the closing unit 71 of the failure detection device 100 can be omitted.

As the control unit 75, for example, a computer having a CPU may be used. The control unit 75 controls the operations of the closing unit 71 and the suction mechanism 73, and compares a detection signal from the piezoelectric sensor 35 of the ink detection unit 11 at that time and a predefined value so as to enable judgment on whether or not the ink detection unit 11 malfunctions.

That is, in the failure detection by the failure detection device 100, the on/off valve mechanism 12 is closed by the closing unit 71, and the choke suction is performed by the suction mechanism 73 in a state where the inflow of ink from the ink pack 7, the sensor chamber 21 becomes the pseudo ink exhaustion state. Accordingly, in the liquid container 1 in which the ink pack 7 and the sensor chamber 21 are pressurized simultaneously, the sensor chamber 21 becomes the pseudo ink exhaustion state, such that the volume of the sensor chamber 21 is reduced. Then, the control unit 75 judges the detection value from the ink detection unit 11 at that time. In such a manner, it is possible to detect an erroneous operation of the ink detection unit 11 that repeatedly detects ink presence when ink is exhausted.

Next, a procedure of a method of detecting a failure of the ink detection unit 11 by the failure detection device 100 will he described in detail.

FIG. 5 is a flowchart showing a procedure of a method of detecting a failure by the failure detection device 100 shown in FIG. 1.

In order to detect a failure of the ink detection unit 11 in the liquid container 1, first, the on/off valve mechanism 12 is closed by the closing unit 71 (Step S1).

Next, the choke suction from the supply port 9 is performed by the suction mechanism 73 (Step S2),

It the choke suction is performed, the pressure receiving plate 27 is moved against the urging force of the compressed coil spring 29 by the negative pressure in the sensor chamber 21 and comes into close contact with the bottom plate 31. Accordingly, as shown in FIG. 4, the volume of the sensor chamber 21 is reduced (Step S3).

At this time, the control unit 75 detects the detection signal from the piezoelectric sensor 35 of the ink detection unit 11 (Step S4).

The control unit 75 judges ink presence/absence from the detection value (Step S5). At that time, if a detection signal of ink presence returns from the ink detection unit 11, it is judged that the ink detection unit 11 is normal (Step S6).

Meanwhile, if a detection signal of ink absence returns from the ink detection unit 11, it is judged that the ink detection unit 11 is abnormal (Step S7).

That is, at the time of the choke suction, even though the sensor chamber 21 is in the pseudo ink exhaustion state, when the detection signal of ink presence returns from the ink detection unit 11, it is judged that the ink detection unit 11 is abnormal.

Then, the control unit 75 causes the display unit 81 to display the failure detection result on the basis of the judgment result (Step S8).

The above-described failure detection device 100 is a single device. The failure detection device 100 may be provided for a final examination process of a production line of the liquid container 1 or may be mounted on the ink jet recording apparatus as a liquid consuming apparatus.

The configurations of the liquid containing chamber, the liquid detection chamber, the detection unit, and the on/off valve mechanism in the liquid container according to the invention are not limited to the configurations of the above-described embodiment. Various configurations can be adopted on the basis of the spirit of the invention.

For example, in the above-described embodiment, the compressed coil spring 29 is used as an urging unit that urges the flexible film 23 and the pressure receiving plate 27 to be separated from the piezoelectric sensor 35.

However, instead of the compressed coil spring 29, an urging unit formed of a different elastic member may be used.

In the above-described embodiment, the time at which the pressure receiving plate 27 partitions the detection space in cooperation with the ink guide path 33 is set to a state where ink of the ink pack 7 is completely exhausted. Then, the piezoelectric sensor 35 functions as an ink end detection mechanism for detecting that the ink residual quantity of the ink pack 7 becomes zero.

However, the time at which the pressure receiving plate 27 partitions the detection space in cooperation with the ink guide path 33 may be set to a state where ink of the ink pack 7 is nearly exhausted (a state where a small amount of ink remains). In this case, the piezoelectric sensor 35 can be used as an ink near-end detection mechanism for detecting a state where the ink residual quantity in the ink pack 7 almost becomes zero.

In the liquid container 1 of the invention, ink stored in the ink pack 7 is discharged from the discharge port 7b by the pressurization of the pressure unit, and the sensor chamber 21 is disposed in a region where the pressure is applied by the pressure unit. However, the liquid container according to the invention is not limited thereto.

For example, a liquid container, in which the liquid stored in the liquid containing charter is discharged from the liquid discharge port through the suction from the supply port, and the liquid containing chamber is not pressurized, may be used.

In the liquid container of the invention, the recess portion serving as the vibration reaction region, in which the detection space is partitioned and to which the pressure detection unit applies the vibration, is not limited to the ink guide path 33 shown in the above-described embodiment. The recess portion according to the invention may have a simple cutout shape to be formed at the top surface of the bottom plate 31, not a tubular path.

The use of the liquid container according to the invention is not limited to the ink cartridge of the ink jet recording apparatus. For example, the liquid container of the invention is used for various liquid consuming apparatuses having a ejection head that ejects a minute amount of liquid droplet.

Specific examples of the liquid consuming apparatus having a liquid ejection head include an apparatus having a color material ejection head used in manufacturing color filters of a liquid crystal display or the like, an apparatus having an electrode material (conductive paste) ejection head used in forming electrodes of an organic electroluminescent (EL) display or a surface emission display (FED), an apparatus having a bioorganic compound ejection head used in manufacturing a bio-chip, an apparatus having a sample spraying head as a precision pipette, a textile printing apparatus, or a micro dispenser.

What is claimed is:

1. A method of detecting a liquid residual quantity in a liquid container, the liquid container including:
a supply port through which a liquid is supplied to a liquid consuming apparatus;
a liquid containing chamber that discharges the liquid stored therein through a liquid discharge port;
a liquid detection chamber that is connected to the liquid containing chamber, a volume of which can be increased according to an inflow of the liquid from the liquid containing chamber and can be reduced when the in flow of the liquid from the liquid containing chamber stops;
a detection unit for detecting a change of the volume of the liquid detection chamber; and
a valve mechanism that is disposed between the liquid containing chamber and the liquid detection chamber and can block the inflow of the liquid from the liquid containing chamber to the liquid detection chamber,
wherein the detection unit performs a detection operation in a state where the volume of the liquid detection chamber is reduced by sucking the liquid in the liquid detection chamber through the supply port while the valve mechanism is closed and in a state where the valve mechanism is opened.

2. The method according to claim 1,
wherein the liquid containing chamber discharges the liquid stored therein through the liquid discharge port by pressurization of a pressure unit, and
the liquid detection chamber is disposed in a region where a pressure is applied by the pressure unit.

3. The method according to claim 1,
wherein when the liquid in the liquid detection chamber is sucked through the supply port while the valve mechanism is closed, it is judged that the detection unit malfunctions if the detection unit detects that the volume of the liquid detection chamber is increased.

4. A failure detection device for a liquid container including a supply port through which a liquid is supplied to a liquid consuming apparatus, a liquid containing chamber that discharges the liquid stored therein through a liquid discharge port, a liquid detection chamber that is connected to the liquid containing chamber, a volume of which can be increased according to an inflow of the liquid from the liquid containing chamber and can be reduced when the inflow of the liquid from the liquid containing chamber stops, a detection unit for detecting a change of the volume of the liquid detection chamber, and a valve mechanism that is disposed between the liquid containing chamber and the liquid detection chamber and can block the inflow of the liquid from the liquid containing chamber to the liquid detection chamber, the failure detection device comprising:
a closing mechanism that closes the valve mechanism;
a suction mechanism that sucks the liquid in the liquid detection chamber through the supply port while the valve mechanism is closed; and
a control unit that judges a malfunction of the detection unit if the detection unit detects that the volume of the liquid detection chamber is increased when the liquid in the liquid detection chamber is sucked through the supply port while the valve mechanism is closed.

5. The failure detection device for a liquid container according to claim 4,
wherein the liquid containing chamber discharges the liquid stored therein through the liquid discharge port by pressurization of a pressure unit, and
the liquid detection chamber is disposed in a region where a pressure is applied by the pressure unit.

6. A liquid consuming apparatus comprising;
the failure detection device according to claim 4,
wherein the liquid container is detachably mounted, and the liquid supplied from the supply port of the liquid container is ejected from a ejection head as a minute amount of liquid droplet.

7. A method of detecting a liquid residual quantity in a liquid container, the liquid container including:
a supply port for supplying a liquid to a liquid consuming apparatus therethrough;
a liquid containing chamber that stores the liquid therein;
a liquid detection chamber that is connected to the liquid containing chamber, a volume of which can be increased according to an inflow of the liquid from the liquid containing chamber and can be reduced when the in flow of the liquid from the liquid containing chamber stops;
a detection unit for detecting a change of the volume of the liquid detection chamber; and
a valve mechanism that is disposed between the liquid containing chamber and the liquid detection chamber and can block the inflow of the liquid from the liquid containing chamber to the liquid detection chamber,
wherein the method comprising:
closing the valve mechanism;
sucking the liquid through the supply port to reduce the volume of the liquid detection chamber; and
detecting the change of the volume of the liquid detection chamber.

8. The method according to claim 7, further comprising:
judging the detection unit as abnormal when a signal output from the detection unit shows that the volume of the liquid detection chamber is increased.

9. The method according to claim 7, further comprising:
judging the detection unit as normal when a signal output from the detection unit shows that the volume of the liquid detection chamber is reduced.

10. The method according to claim 8, further comprising: displaying the abnormality.

11. A liquid container comprising;
a first pressure chamber in which a first pressurized fluid can be introduced;
a second pressure chamber in which a second pressurized fluid can be introduced, and which is not in fluid communication with the first pressure chamber;
a liquid containing chamber that stores a liquid therein;
a liquid detection unit for detecting a change of a volume of the liquid containing chamber, including a liquid detection chamber that is connected to the liquid containing chamber, and a volume of which can change according to an inflow amount of the liquid from the liquid containing chamber; and
a flexible member that defines at least a part of a flow passage connecting the liquid containing chamber and the liquid detection chamber to each other and can block the flow passage,
wherein the liquid detection chamber and the liquid containing chamber are disposed so as to reduce its volume due to the first pressurized fluid to be introduced in the first pressure chamber, and
wherein the flexible member is disposed so as to block the flow passage due to the second pressurized fluid to be introduced in the second pressure chamber.

12. The liquid container according to claim 11,
wherein the liquid detection chamber is formed by sealing an opening formed at its upper surface with a film that is deformable according to a liquid containing amount of the liquid detection chamber, and the detection unit is disposed at the bottom of the liquid detection chamber.

13. The liquid container according to claim 12,
wherein a moving member is attached to the film so as to move by the deformation of the film corresponding to a change of the liquid containing amount of the liquid detection chamber.

14. The liquid container according to claim 13,
wherein the detection unit is a piezoelectric detection unit that has a recess portion formed in the liquid detection chamber so as to form a closed space in cooperation with one surface parallel to a horizontal surface of the moving member in a state where the moving member moves to the predetermined position according to the liquid containing amount of the liquid detection chamber, and
the piezoelectric detection unit applies vibration to the recess portion and detects a free vibration state according to the applied vibration.

15. The liquid container according to claim 14,
wherein the moving member has, in a region facing a vibration surface of the piezoelectric detection unit, a surface substantially parallel to the vibration surface.

16. The liquid container according to claim 14,
wherein the moving member is urged by an urging unit in a direction opposite to a direction in which the piezoelectric detection unit is disposed.

17. The liquid container according to claim 16,
wherein the urging unit is formed of an elastic member.
